(19) United States
(12) Patent Application Publication
(10) Pub. No.: US 2001/0046543 A1
(43) Pub. Date: Nov. 29, 2001

(54) Method for the pasteurisation of drinks, in particular beer

(76) Inventor: Peter Land, Ruthen-Meiste (DE)

Correspondence Address: Daniel F. Drexler, 55 Griffin South Road, Bloomfield, CT, 06002, US

(21) Appl. No.: 09/834,140

(22) Filed: Apr. 12, 2001

(30) Foreign Application Priority Data
Apr. 15, 2000 (DE) 100 18 741.2

(51) Int. Cl. C12H 1/00

(52) U.S. Cl. 426/521; 426/16

(57) ABSTRACT

The present invention relates to a method for the pasteurisation of drinks, in particular beer, by thermal treatment, in which before being filled into its containers a flow volume of the product is heated above a pasteurisation temperature and then cooled again, such that immediately after a heating phase (30) which lasts until a previously calculated maximum temperature (33) has been reached, the cooling phase (34) with decreasing product temperatures is commenced. In the method according to the invention there is no heat holding period during which the temperature is held constant. The method enables a high product temperature to be reached without exceeding the limits specified for the pasteurisation units applied.

The present invention relates to a method for the pasteurisation of drinks, in particular beer, according to the pre-characterising portion of claim 1. The purpose of pasteurisation is to establish biological stability by killing micro-organisms that may be present in the beer as completely as possible without any adverse effect on the quality of the product.

The pasteurisation methods in common use nowadays are all based on the fact, discovered by Louis Pasteur, that the shelf life of foodstuffs can be prolonged by heating to temperatures above about 60° C.

In practice, the methods used are divided essentially according to two principles:

Pasteurisation of the product in the drink container once it has been filled.

Pasteurisation of the product in the continuous flow mode (short-time heating; STH).

The temperatures customarily used in practice for the pasteurisation of drinks, for example beer in drink containers, range from about 65° C. to 68° C. and in the other case are usually not over 72° C. The background and methods are sufficiently well known and described in the literature on the subject.

### Definition of the Pasteurisation Units (PU)

The killing effect on micro-organisms produced by heating is determined by two parameters, which have to be determined specifically for each micro-organism:

D-value (decimal reduction time)D_{ΘH}

The D-value indicates how long the temperature must be held at the index value in order to have the effect of reducing live micro-organisms by 90% (one power of ten).

z-value

The z-value expresses by how many ° C. the holding temperature given in the D-value index must be increased or decreased, in order to reduce the D-value to one-tenth or increase it by a factor of ten.

The mathematical relationship involving these parameters is as follows:

$${D}_{ϑ2} = {D}_{ϑ1} * {10}^{( \frac{( ϑ1 - ϑ2 )}{z} )}$$

For the parameters:

D_{Θ1}=tₕ (heat holding time)

Θ1=Θh

Θ2=60° C.

z=6.95° C.

and by transformation, the above equation becomes the numerical value equation quoted everywhere in the literature:

PU=tₕ*1,393^{(Θh-60° C.)}

In this, 1 PU is defined as the degree of annihilation achieved by a heat holding time of 1 minute at 60° C. Strictly speaking, however, this only applies to micro-organisms which also correspond to a z-value of 6.95, but this is unfortunately neglected in the numerical equation.

With other bacterial species the z-value may be different, so that there will then also be a different value for the hot holding time. Furthermore, the pasteurisation temperature used in the equation need not necessarily be 60° C., but may be chosen differently.

By using the heat holding temperature (Θh) and heat holding time (tₕ) as constant magnitudes, the PU values with which the product is treated are determined.

### Existing Methods (thermal steady-state)

Pasteurisation equipment that works in the continuous flow mode and is relevant to the method according to the invention, is usually referred to in industry as short-time heating (STH) equipment.

Such STH equipment works as follows:

The product flows into the recuperator at its inlet temperature and is heated by heat transfer from the product stream flowing out. After the recuperator the product is brought to a higher pressure level by a pump, and this prevents any unpasteurised product from entering the pasteurised product stream via leak points in the recuperator. Thereafter, the product flows through the heater where it is raised to the heat holding temperature by a hot water circuit. After being heated to the heat holding temperature, the product flows into the heat holding chamber which in most cases consists of a simple tube arranged in loops. A few manufacturers make the heat holding chamber in the form of a plate stack with no heat transfer function. The essential factor is the holding time during which the product remains in the heat holding chamber while it is flowing through, which is determined by the volume of the holding chamber and the flow volume. It should be noted that for the calculation of the PU value, the relevant factor is the constant (thermal steady-state) temperature in the heat holding chamber. Subsequently, the product flows from the holding chamber into the recuperator where it transfers heat to the incoming product. Depending on the outflow temperature desired, an after-cool section can follow if the outflow temperature reached in the recuperator is not low enough.

From DE 43 38 334 C1 a method of the type described above for the pasteurisation of beer by thermal treatment is known. In this known method the inflowing beer is first heated in a recuperator and then raised to the necessary pasteuristion temperature in a heater. On emerging from the heater, the beer heated to pasteurisation temperature passes into a heat holding chamber in which it is held at the pasteurisation temperature for a certain time. Only then, in a further process step, is the beer flow volume cooled. Accordingly, this method corresponds to the previously known thermal steady-state method.

As a result of more recent investigations aiming to improve the quality of beer, it was established that certain quality-reducing enzymes present in the beer are neutralised at temperatures higher than usual for pasteurisation today, and that in doing this the time for which the heat acts upon the enzymes probably plays a smaller part than the attainment of a given temperature level.

The objective stemming from this is that of developing a pasteurisation method, which on the one hand does not exceed the PU limits that have proved their worth in practice (as a rule between 10 PU and 30 PU), but on the other hand one which gives the highest possible product temperature during the thermal treatment.

This objective is achieved by a method according to the invention for the pasteuristion of drinks, in particular beer, having the characteristic features of the principal claim.

The structure of the STH unit according to the thermal non-stead state method proposed here differs essentially in that no heat holding chamber is used. The consequence of the requirement for as high a temperature as possible and the definition that pasteurisation begins above the temperature Θ2 (e.g. 60° C.) is that the temperature variation in the recuperator on the cooling and heating side and in the heater in the temperature range above Θ2 can no longer be disregarded. The maximum temperature is reached when the product has been subjected to exactly as many PU as desired by the heating and back-cooling process. In this, the temperature changes should take place as rapidly as possible so that the PU can be applied at the highest temperature possible. If the temperatures are to be changed even more rapidly than is possible by virtue of the recuperative structure of a STH unit of the usual type, it would be necessary to apply outside cooling and to increase the temperature differences between the heating and product flows. (This, however, would decrease the heat recovery in the unit and hence reduce its economy.)

Knowledge of the design features of a heat transfer apparatus and the flows through it enables the temperature variations to be determined mathematically. In this, it is preferable to minimise the volume between the heat transfer plates and to maximise the k-value. At the same time, the transverse flows—the area in which the flow is distributed over the plates—and the casing (when the product is above 60° C. at such points) should preferably be designed as small as possible. In particular, the distance between the heater outlet and the recuperator inlet on the cooling side should be kept as short as possible, since that is where the maximum temperature prevails. Depending on the desired outflow temperature from the STH unit, an after-cooler or heater can be used.

A computation process is used to determine and summate the PU values taking into account the temperature variation in the individual sections. If the desired PU value is not attained by the control parameters set, the maximum temperature is increased or reduced accordingly.

In the method according to the invention, the essential objective is to produce a high maximum temperature of the product while respecting the PU limits as closely as possible.

In this, the essential influencing parameters are the volume in the STH unit, the flow volume of the product, the temperature variation between inlet and outlet, and the heat transfer properties of the STH unit.

The characteristic of the method according to the invention is that no heat holding chamber is used and a PU computation for the heating and cooling phase is carried out.

In what follows, the present invention will be described in greater detail with reference to example embodiments illustrated in the accompanying figures, which show:

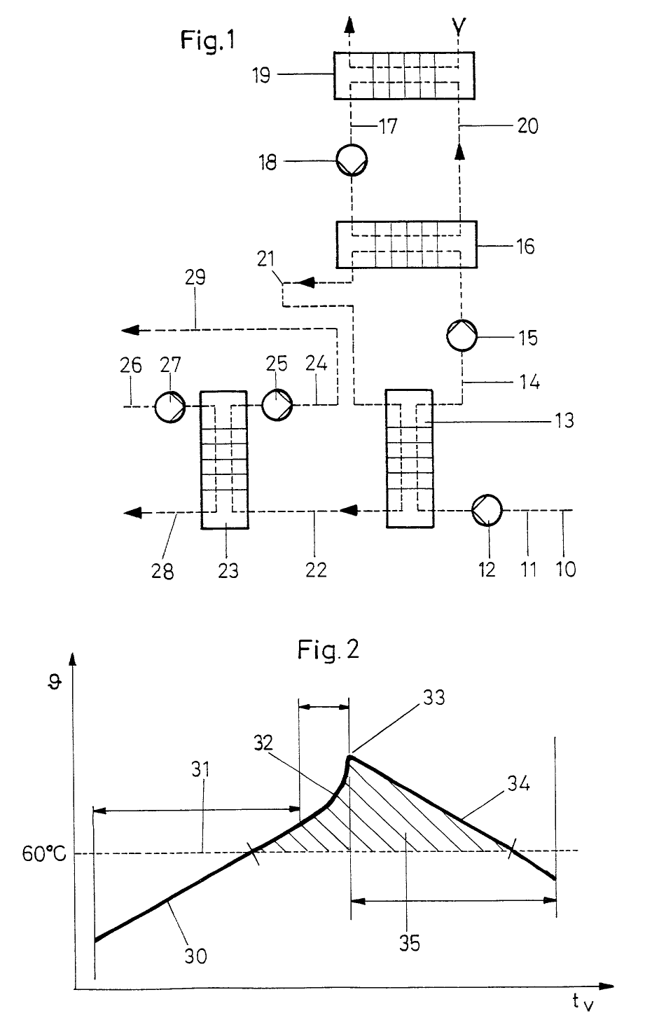

FIG. 1: Principle of the structure of a STH unit according to the invention, with thermal non-steady-state pasteurisation

FIG. 2: Principle of the temperature variation in a pasteurisation process according to the invention

### Reference is first made to FIG. 1.

The product to be pasteurised, in this case beer, enters the unit through the product inlet 10 and is conveyed to the recuperator 13 through a pipe 11 by a pump 12. There, the product is heated by the outflowing hot product stream. The product so heated leaves the recuperator 13 via the pipe 14 and is conveyed by a pump 15 to the heater 16. As in the recuperator 13, so too in the heater 16 the product flows counter-current to a medium used for heating, in this case hot water. The hot water flowing in counter-current mode is conveyed to the heater 16 from the water heater 19 by a pump 18 via a pipe 17, and then leaves the heater via a pipe 20.

The product leaves the heater 16 via a pipe 21 and, on emerging from the heater, has as a rule reached its maximum temperature. The product then flows through the recuperator 13 in counter-current to the fresh product flowing from the pipe 11 into the recuperator where it is heated.

After cooling, the pasteurised product leaves the recuperator 13 via a pipe 22 and flows into an after-cooler 23, out of which it is pumped via a pipe 24 by a pump 25. Advantageously, in the after-cooler 23 too the coolant medium flows in counter-current mode. For this, the coolant is conveyed by a pump 27 to the coolant inlet 26 and into the after-cooler 23, through which it flows counter-current to the cooling product and then leaves the after-cooler 23 via a pipe 28. The after-cooler 23 can also be used as a heater if necessary, in which case a heating medium instead of a coolant is passed in via the pipe 26 and out via the pipe 28.

The product, which has been cooled in the after-cooler 23, then flows via the pipe 24 to the product outlet (beer outlet) 29, where the pasteurised product leaves the unit.

The principle of the temperature variation in a pasteurisation process according to the invention is shown in the schematic representation of FIG. 2. This shows a graph in which temperature Θ is plotted against dwell time tᵥ. In this case the pasteurisation temperature is chosen as 60° C. and is represented by the broken line. As can be seen, the product to be pasteurised is heated in the recuperator during a heating phase 30, and in this heating phase 30 it is heated above the pasteurisation temperature (broken line 31). Thereafter, further heating takes place during the second heating phase 32 in the heater up to the maximum temperature. The maximum temperature is indicated as 33. Once the maximum temperature 33 has been reached the product is cooled in the recuperator, the cooling phase being indicated as 34. From the figure it is apparent that no holding period in which the temperature is held constant is involved, but rather, the cooling phase 34 begins immediately after the maximum temperature 33 has been reached. The product is then cooled in the recuperator to below the pasteurisation temperature (broken line 31). The area within which pasteurisation units are applied to the product is the total area under the curve in the region of the heating phases 31, 32 and the cooling phase 34 located above the pasteurisation temperature. This area, which is taken into account to compute the pasteurisation units, is indicated as 35 on the diagram and identified by hatching.

Below, a numerical example of a pasteurisation process according to the invention, taking place under thermal non-stead-state conditions, is contrasted against a comparison example. The figures for the comparison example according to the state of the prior art, i.e. operating in the thermal steady-state mode with a heat holding chamber, are shown in the lower part of the table in the left-hand column, and the corresponding figures for the method according to the invention are shown on the right, alongside.

### Comparison of PU Values for Thermal Stead-state and Non-steady-state Processes

| | | Pasteurisation method | |
|---|---|---|---|
| | | Thermal | Thermal non- |
| | Unit | steady-state | steady-state |
| PU value required | [PU] | 22.5 | |
| Product flow | [m³/h] | 40 | |
| volume | | | |
| Number of plates | [No.] | 100 | |
| in the recuperator | | | |
| Number of plates | [No.] | 35 | |
| in the heater | | | |
| Volume per slot | [l] | 2.33 | |
| Area per plate | [m²] | 0.661 | |
| Heat holding | [° C.] | 80 | No heat holding |
| temperature | | | chamber |
| Maximum | [° C.] | 80 | 80 |
| temperature | | | |
| Recuperator | [PU] | 0.2 | 0.2 |
| heating side | | | |
| Heater | [PU] | 16.4 | 16.4 |
| Heat holding | [PU] | 22.5 | No heat holding |
| chamber | | | chamber |
| Recuperator | [PU] | 5.9 | 5.9 |
| cooling side | | | |
| Total | [PU] | 45 | 22.5 |
| Overpasteurisation | [PU] | 22.5 | 0 |

In a conventional STH unit PUs are applied only in the hot holding chamber. If the number of pasteurisation units required is 22.5 PU and the hot holding temperature is 80° C., the temperature should be maintained in the holding chamber for approximately 1.8 s. In this, any PUs applied during heating and cooling are disregarded!

The thermally non-stead state pasteurisation takes into account only PUs applied during the heating and cooling, and does not involve a heat holding chamber. In the above example, for the required PU value of 22.5 PU a maximum temperature of 80° C. is needed. Beyond this, no additional PUs are applied. Thus, the relative error produced by a unit operating in the thermal steady-state made amounts in the example considered to 100%.

1. Method for the pasteurisation of drinks, in particular beer by thermal treatment, in which a flow volume of the product is heated above a pasteurisation temperature and then cooled again before it is filled into its containers, characterised in that immediately after a heating phase (30) that lasts until a previously calculated maximum temperature (33) has been reached, the cooling phase (34) in which the product's temperature decreases is commenced, such that a maximum quantity of pasteurisation units (PU) to be applied for the pasteurisation of the specific product is first computed, and the temperature variation in the heating phase (30), the length of the heating phase, and the temperature variation and length of the cooling phase (34), are then chosen so that during pasteurisation, the number of pasteurisation units previously calculated corresponds to the total number of pasteurisation units actually applied during the heating and cooling phases.

2. Method for the pasteurisation of drinks, in particular beer, according to claim 1, characterised in that a pasteurisation unit is defined as:
PU=tₕ*1,393^{(Θh-Θ2)}.

3. Method for the pasteurisation of drinks, in particular beer, according to claims 1 or 2, characterised in that the heating phase (30) in the temperature range within which pasteurisation takes place (above the pasteurisation temperature Θ2) is shorter than the cooling phase (34) (above the pasteurisation temperature).

4. Method for the pasteurisation of drinks, in particular beer, according to any of claims 1 to 3, characterised in that in the heating phase (30) the product stream is heated in a recuperator by heat transfer from the outflowing product stream.

5. Method for the pasteurisation of drinks, in particular beer, according to any of claims 1 to 4, characterised in that additional heating by a medium with higher temperature, in particular hot water or steam, is provided.

6. Method for the pasteurisation of drinks, in particular beer, according to any of claims 1 to 5, characterised in that at the conclusion of the heating in a recuperator, heating in a heater takes place at least during a part (32) of the heating phase.

7. Method for the pasteurisation of drinks, in particular beer, according to any of claims 1 to 6, characterised in that at least part of the cooling during the cooling phase (34) takes place in a recuperator, with the outflowing beer stream to be cooled flowing counter-current to the inflowing beer stream to be heated.

8. Method for the pasteurisation of drinks, in particular beer, according to any of claims 1 to 7, characterised in that the product stream is cooled in a heat exchanger by means of an outside medium.
